(19) United States
(12) Patent Application Publication
(10) Pub. No.: US 2026/0195841 A1
(43) Pub. Date: Jul. 9, 2026

(54) System and Method for Utilizing Casino Points to Satisfy Financial Service Fees

(71) Applicant: Passport Technology, Inc., Las Vegas, NV (US)

(72) Inventors: John Steely, Glendale, CA (US); Matthew Kaedbey, Burbank, CA (US); Arun Yegappan, Las Vegas, NV (US); Kurt Sullivan, Las Vegas, NV (US); Jason King, Las Vegas, NV (US)

(21) Appl. No.: 19/315,301

(22) Filed: Aug. 29, 2025

Related U.S. Application Data
(63) Continuation-in-part of application No. 18/377,995, filed on Oct. 9, 2023, now abandoned.
(60) Provisional application No. 63/414,174, filed on Oct. 7, 2022.

(51) Int. Cl. G06Q 50/34; G06Q 30/0226

(52) U.S. Cl. CPC G06Q 50/34; G06Q 30/0233

(57) ABSTRACT

A system and method for facilitating cash access for casino patrons, using casino points and casino complimentary dollars to satisfy financial service fees imposed on casino patrons via cage cashiers, mobile devices, and redemption kiosks that perform ATM functions, debit and credit transactions, check cashing, gaming wallet transactions, and crypto currency transactions for cash access.

### CROSS-REFERENCE TO RELATED APPLICATIONS

The present application is a continuation in part of application Ser. No. 18/377,995, filed Oct. 9, 2023, which takes priority from App. No. 63/414,174, filed Oct. 7, 2022, which are both incorporated herein by reference.

### BACKGROUND

Casinos typically offer their patrons reward points and “comps” as an incentive to continue gaming. Those points can typically be redeemed for casino services or services offered by the casino's partner businesses, such as restaurants, hotels, or shops. The purpose of these points is to incentivize the customer to continue gaming and to use the services offered by casino partners.

When a customer needs to withdraw cash or to perform another financial transaction at a casino, they typically use a kiosk such as an ATM. To perform financial transactions at such a kiosk, the customer typically has to pay a fee. In the prior art systems, this fee has to be paid in cash. This has a disincentivizing effect on the customer, since this fee is coming directly out of their bank account.

A need exists for a more frictionless and less disincentivizing method of funding financial transactions.

### SUMMARY OF THE INVENTION

An object of the present invention is to provide a frictionless way for customers to make cash withdrawals at a casino.

Another object of the present invention is to provide a way for customers to pay ATM fees at a casino using reward points.

Another object of the present invention is to increase a casino's income.

In an embodiment of the present invention, the method of the present invention could comprise initiating a transaction using a computing device and using the computing device to compute a financial transaction fee amount associated with the transaction. The computing device then connects to a casino management system via a gateway. The gateway requests information from the casino management system to ensure that a patron account exists and is active. If it is, the gateway then requests the location and conversion value associated with the location where it is, and then converts the financial transaction fee to a reward point amount using the conversion value. The gateway then sends a request to the casino management system to withdraw required points/comps from the patron's account. Based on the available balance, the casino management system either authorizes or declines the withdrawal. In case of declined request, the transaction is denied to the patron at the kiosk.

In an embodiment, if the patron account does not exist or is not active, the computing device displays an invalid account status.

In an embodiment, the gateway, computing device, and casino management system communicate through REST API methods.

In an embodiment, the locations are stored in a database along with a reward point exchange rate and a comp dollar exchange rate associated with each location.

In an embodiment, the transaction database contains at least the following: transaction ID, patron account number, fee cash value, number of points used, amount of comp dollars used, cash remainder used, status, date.

The transaction could be a debit card withdrawal, a credit card withdrawal, an ATM transaction, a check cashing transaction, or a cryptocurrency transaction.

The system of the present invention may comprise a computing device located at a casino, a gateway connected to the computing device, and a casino management system connected to the gateway. The present invention gateway comprises a location database and a transaction database.

### LIST OF FIGURES

FIG. 1 shows a flowchart of an embodiment of the method of the present invention.

FIG. 2 shows a flowchart of an embodiment of the method of the present invention.

FIG. 3 shows a flowchart of an embodiment of the method of the present invention.

FIG. 4 shows sample screenshots of an embodiment of the method of the present invention.

FIG. 5 shows sample screenshots of an embodiment of the method of the present invention.

FIG. 6 shows sample screenshots of an embodiment of the method of the present invention.

### SUMMARY OF THE INVENTION

The primary object of the present invention is to provide a method to convert the transaction fee amount from cash to reward points or Comp Dollars.

Another object of the present invention is to provide a method to verify that the patron's loyalty account is in good standing and has a balance of more than the required amount of points or Comp Dollars for withdrawal.

Another object of the present invention is to provide a method to subtract the amount of reward points used form the patron's reward point balance or Comp Dollars balance.

A further object of the invention is to record the transaction in the invention's database to be used for record keeping purposes and auditing purposes.

The present invention comprises of a software gateway that connects to payment products on one end and Casino Management Systems (CMS) on the other to convert fees from cash values to reward points. The gateway uses REST APIs to receive the fees and patron's loyalty account number, verify that the account exists and is in good standing, convert the cash value of the fee to reward points or Comp Dollars and retrieve the reward point balance of the patrons. The patron is then presented with the option of using their point balance or Comp Dollars balance to pay for the financial transaction fees. Once approved, the gateway requests from the CMS that the points or Comp Dollars are deducted from the patron's reward point balance which resides in the Casino Management System database. A record of the transaction is stored in the gateway's database.

To the accomplishment of the above and related objects, this invention may be embodied in the form illustrated in the accompanying drawings.

### DETAILED DESCRIPTION

The present invention may be operated as a computer program installed on a cloud system or installed on a local server at the casino location.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium with or without a computer or a web server that merely provide the results of the analyzed patent data.

The global computer network (e.g. Internet) is an exemplary communications network for the present invention. The Internet is basically comprised of a “global computer network.” A plurality of computer systems around the world are in communication with one another via this global computer network and are able to transmit various types of data between one another. The communications between the computer systems may be accomplished via various methods such as but not limited to wireless, Ethernet, cable, direct connection, telephone lines, and satellite. One or more web servers typically provide the data to the computer systems connected via the Internet.

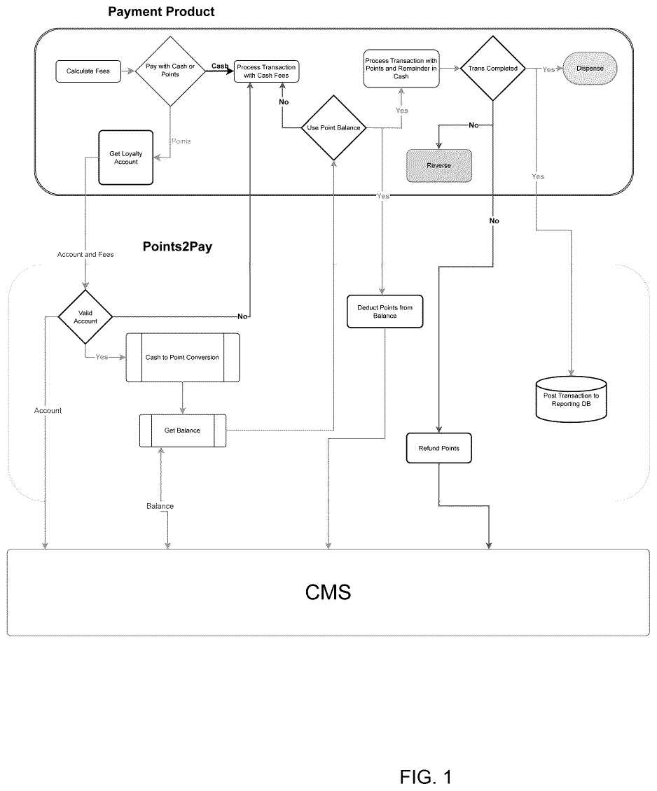

As shown in FIG. 1, the present invention first receives the cash value of the financial transaction fees, the location ID and the patron's loyalty account number. The request is sent by the payment product through REST API methods. Once this information is received, the gateway establishes a secure connection to the CMS using provided API endpoints and login credentials. The gateway sends a request to the Casino Management System (CMS) through predefined API methods inquiring about the existence and standing of the account. The CMS will reply to the API request with the status of the account (exists or does not exist) and the account standing (active or inactive). If the account does not exist or is inactive, the gateway returns an invalid account status to payment product. This reply instructs the payment product to provide the patron with one option for processing the financial transaction using cash to pay for the fees. The gateway logs the transaction information in the database for auditing purposes.

If the account exists and is active, the gateway requests the location's configuration parameters though store procedure from the Gateway's database. The configuration parameters include but not limited to the location name and conversion value. The conversion value is used to convert the cash value of the transaction fees to a reward point value commensurate with the location's desired exchange rate.

The gateway converts the cash value of the transaction fees to reward points or Comp Dollars. The gateway sends a request to the CMS through predefined API Methods to retrieve the patron's current reward point balance.

The gateway then sends the request to the casino management system to withdraw the converted points or Comp Dollars needed to satisfy the fees for the transaction.

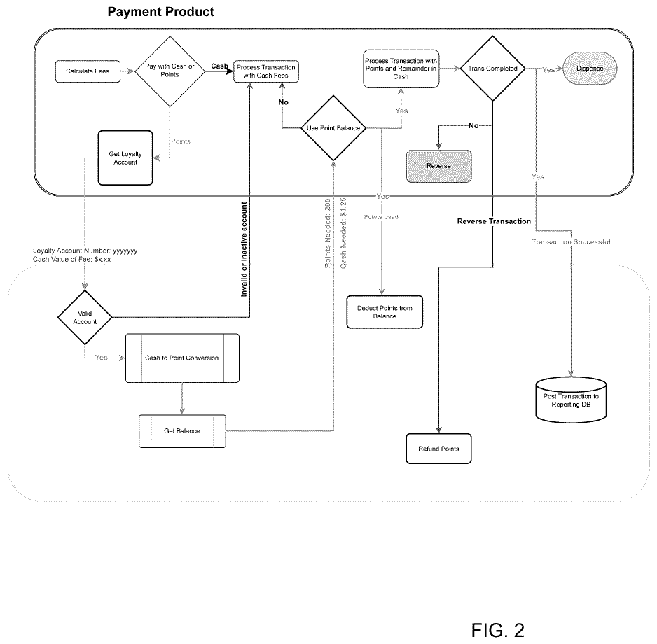

FIG. 2 shows the process of communicating with the payment product, whether it is a cage terminal, kiosk, ATM, handheld payment terminal, or casino wallet.

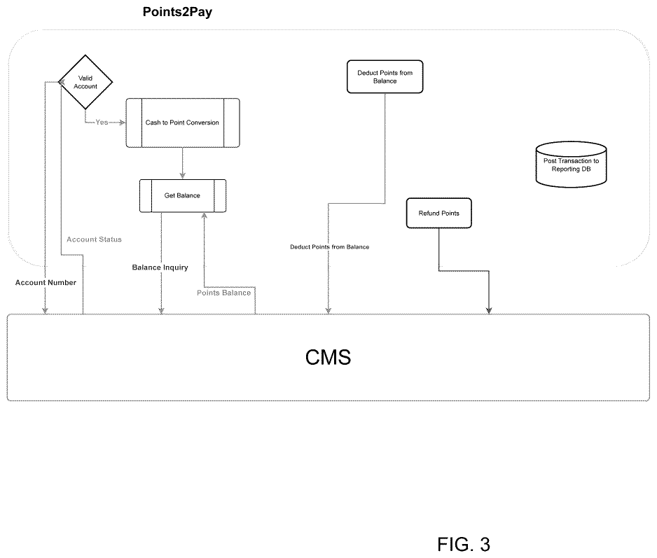

FIG. 3 shows the process of communicating with the CMS to retrieve the account status, reward point balance, and deducting the points used from the aforementioned balance.

The below examples are used to illustrate the operation of a particular embodiment of the present invention. They are not meant to be limiting; the invention is only limited by the appended claims.

Example 1:
Fee needed to complete the transaction: $4.99
Exchange rate: 100 points converts to $1.00
Points needed to complete the transaction: 499 points
Patron's point balance: 200 points
499 points needed−200 points balance=299 points
Reply sent to Payment product: 200 points+$2.99
Points Balance: 0 points

Example 2:
Fee needed to complete the transaction: $3.99
Exchange rate: 100 points converts to $1.00
Points needed to complete the transaction: 399 points
Patron's point balance: 705 points
399 points needed−705 points balance=306 points
Reply sent to Payment product: 399 points+$0.00
Points Balance: 306 points

The payment product offers the patron the option to pay for the transaction fees using their points or Comp Dollars. If the patron chooses to use their points or Comp Dollars, a request is sent to the gateway to deduct the number of points or Comp Dollars used from the patron's balance. The gateway sends a request to the CMS through predefined API Methods to deduct the number of points or Comp Dollars used form the patron's reward point or dollar balance. The payment product proceeds with the transaction where the fee value is equal to the remainder of the cash value needed to satisfy the transaction fees received from the gateway.

Should the transaction not complete on the payment processor side (insufficient funds, incorrect PIN or other reasons), the payment product sends a request to void the transaction to the gateway. The gateway sends a request to the CMS through predefined API Methods to void the withdrawal request. The CMS voids the earlier withdrawal request and updates the player's account balance.

Should the transaction successfully complete on the payment processor side, the payment product sends a notification to the gateway that the transaction completed successfully. The gateway then records the transaction information in the database using predefined stored procedures and proceeds to close the connection to the CMS.

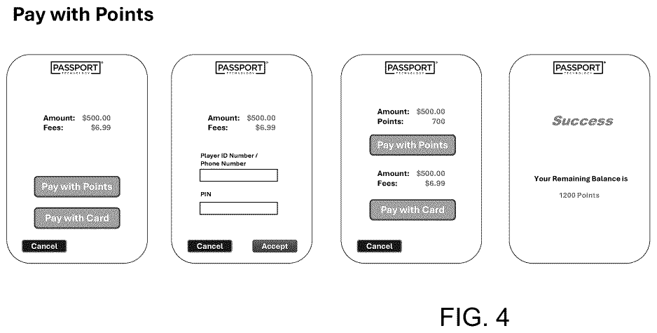

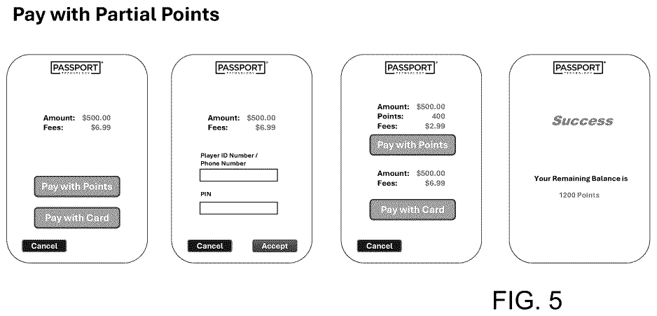

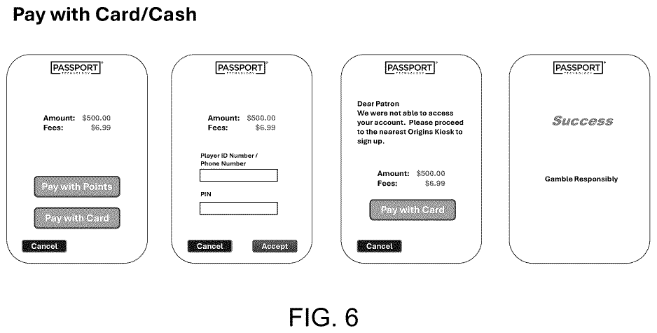

FIGS. 4-6 show a series of screenshots of an embodiment of the present invention, as seen by the consumer.

The present invention requires a database to operate. The database of the present invention can be written in any language, but is preferably written in SQL or Oracle. The database and any applications used with it may reside on one server or multiple servers - for example, database servers, web servers, and network attached storage. The server or servers preferably communicates with the rest of the system through Origins API.

The exact fields of the database can vary; below is a sample listing of database fields used for one embodiment of the present invention. It is not meant to be limiting.

Location Table
Location ID
Location Name
CMS end points and credentials
Reward Points Exchange rate
Comp Dollars Exchange rate
Other fields required for database maintenance and efficiency but not directly related to this invention

Transaction Table
Transaction ID
Patron Account number
Fee Cash Value
Number of Points used
Amount of Comp Dollars used
Cash remainder used
Status
Date
Time
Other fields required for database maintenance and efficiency but not directly related to this invention

The computing device located at the casino may be a kiosk, a computer, or an ATM. While a kiosk is described below, this is not meant to be limiting. As shown in the Figure, the kiosk is connected to the server that stores the database, as well as to a bank or other financial server that provides the financial information to complete the transaction.

To practice an embodiment of the present invention, a debit/ACH account is set up for each casino participating in the system. Typically, casinos have a marketing/debit account for merchandise bought with comps; this would be a separate account that would be used for bank fees.

In an embodiment of the invention, when a customer decides to use their point balance or comp balance to pay a financial services fee, the kiosk accesses the database and retrieves the customer's identifying information and point balance. The kiosk then determines whether or not the customer has enough points to pay the financial services fee. If that is true, the kiosk deducts the appropriate number of points from the customer's point balance and updates the database accordingly. The funds are then taken out of the casino's debit/ACH account and transmitted to the bank, ATM owner, or both. In an embodiment of the invention, to simplify accounting, funds are transferred only once a day for all the transactions made that day. It is to be understood that any other schedule of transfers of funds is consistent with the present invention, and that funds may be transferred weekly, monthly, or after every transaction, or at any other frequency.

For all the embodiments of the system, the key distinction of the invention from the prior art is that points or comps are used to pay transaction fees for financial transactions. The advantage of this is that it encourages the customer to make more financial transactions, increases revenue for the casino, and benefits the bank by encouraging more financial transactions and fees.

The advantage of the present invention is that customers frequently hesitate to use ATM's for cash withdrawal or other financial transactions because of the high fees involved. Because these transactions happen so frequently in a casino context, this hesitation can be costly to the casino insofar as it discourages further gaming. Since customers do not see casino points the same way they would see “real money,” a customer would not hesitate as much to make cash withdrawals or other financial transactions if points were used instead.

Another advantage of the present invention is that it allows the casino to benefit from the customer's financial transactions. As mentioned in the disclosure, in one of the embodiments of the invention, the fee is higher if the customer uses points than if the customer uses cash. The casino then keeps part of that higher fee.

Another advantage of the present invention is that it encourages customers to perform more financial transactions, which benefits the bank.

Exemplary embodiments are described above. It is to be understood that any reasonable equivalents to the above embodiments are included in the present disclosure.

1. A method, comprising:
initiating a transaction by using a computing device;
using the computing device to compute a financial transaction fee amount associated with a transaction;
using the computing device to connect to a casino management system via a gateway;
using the gateway to request information from the casino management system using an API method, wherein the information comprises the existence and active status of a patron account;
if the patron account exists and is active, using the gateway to request a location of the computing device and a conversion value associated with the location;
using the gateway to convert the financial transaction fee amount to a reward point amount using the conversion value;
using the gateway to send a request to the casino management system to retrieve a current reward point balance associated with the patron account;
using the gateway to request from the CMS the deduction of the reward point amount from the current reward point balance to result in an updated reward point balance;
using the gateway to record transaction information in a transaction information database.

2. The method of claim 1, further comprising:
if the patron account does not exist, using the computing device to display an invalid account status;
if the patron account is inactive or banned, using the computing device to display an invalid account status.

3. The method of claim 1, wherein the gateway, computing device, and casino management system communicate with each other through REST API methods.

4. The method of claim 1, wherein the step of using the gateway to request a location of the computing device and a conversion value associated with the location comprises inquiring in a location database, wherein the location database contains at least one of the following information fields: location ID, location name, casino management system end points and credentials, reward points exchange rate, comp dollars exchange rate.

5. The method of claim 1, wherein the transaction database contains at least one of the following information fields: transaction ID, patron account number, fee cash value, number of points used, amount of comp dollars used, cash remainder used, status, date.

6. The method of claim 1, wherein the transaction is a debit card transaction.

7. The method of claim 1, wherein the transaction is a credit card transaction.

8. The method of claim 1, wherein the transaction is a check cashing transaction.

9. The method of claim 1, wherein the transaction is a cryptocurrency transaction.

10. The method of claim 1, wherein the computing device is a kiosk.

11. The method of claim 1, wherein the computing device is an ATM.

12. A system for managing a financial transaction for a customer at a casino through a bank, comprising:
a computing device located at the casino;
a gateway connected to the computing device;
a casino management system connected to the gateway, wherein the casino management system comprises the following databases:
a location database, wherein the location database contains at least one of the following information fields: location ID, location name, casino management system end points and credentials, reward points exchange rate, comp dollars exchange rate;
a transaction database, wherein the transaction database contains at least one of the following information fields: transaction ID, patron account number, fee cash value, number of points used, amount of comp dollars used, cash remainder used, status, date;
wherein the computing device is configured to perform the following actions:
providing a user interface to enable a customer to initiate a transaction;
computing a financial transaction fee amount associated with a transaction;
connecting to the gateway;
receiving information from the gateway;
wherein the gateway is configured to perform the following actions:
requesting information from the casino management system using an API method, wherein the information comprises the existence and active status of a patron account;
if the patron account exists and is active, requesting a location of the computing device and a conversion value associated with the location;
converting the financial transaction fee amount to a reward point amount using the conversion value;
sending a request to the casino management system to retrieve a current reward point balance associated with the patron account;
sending a request to the casino management system to deduct the reward point amount from the current reward point balance to result in an updated reward point balance;
recording the transaction information in a transaction information database.
